(19) United States
(12) Patent Application Publication
(10) Pub. No.: US 2014/0302479 A1
(43) Pub. Date: Oct. 9, 2014

(54) BRIDLE AND HALTER INSTRUCTIONAL METHOD

(71) Applicant: Dawn LANE, Raceland, KY (US)

(72) Inventor: Dawn LANE, Raceland, KY (US)

(21) Appl. No.: 14/312,059

(22) Filed: Jun. 23, 2014

Related U.S. Application Data
(63) Continuation of application No. 13/208,492, filed on Aug. 12, 2011, now abandoned.

(51) Int. Cl. G09B 1/00

(52) U.S. Cl. CPC G09B 1/00
USPC 434/365

(57) ABSTRACT

An instructional system for placing headgear on an animal such as a horse including a headgear assembly such as a halter or bridle, wherein the headgear assembly further includes multiple interconnected structural components; and a plurality of individual color-coded sleeves releasably mounted on certain of the independent interconnected components, wherein the color of each of the color-coded member corresponds both to a predetermined location on the head of the animal and to a particular step in a predetermined method for placing the headgear assembly on the head of the animal.

### CROSS-REFERENCE TO RELATED APPLICATIONS

This patent application is a continuation of U.S. patent application Ser. No. 13/208,492 filed on Aug. 12, 2011 and entitled “Bridle and Halter Instructional System”, the disclosure of which is hereby incorporated by reference herein in its entirety and made part of the present U.S. utility patent application for all purposes.

### BACKGROUND OF THE INVENTION

The described invention relates in general to devices and methods for guiding or handling animals, and more specifically to a color-coded instructional system for properly placing headgear on an animal such as a horse.

The safe handling of large animals such as horses and/or other livestock typically involves the use of a headgear assembly such as a halter or a bridle. While these devices are very common, proper placement of a halter or a bridle on the head of a horse is not intuitive and if not done correctly may result in injury to the animal, the person working with the animal, or both. Few educational devices or methods are available for providing would-be equestrians with effective training with regard to haltering and/or bridling a horse. Therefore, there is an ongoing need for an easy to use and easy to understand instructional system for accomplishing these or similar tasks.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, an instructional system for placing headgear on an animal is provided. This system includes a headgear assembly such as a halter or bridle, wherein the headgear assembly further includes multiple interconnected structural components; and a plurality of individual color-coded members releasably mounted on certain of the independent interconnected components, wherein the color of each of the color-coded member corresponds both to a predetermined location on the head of the animal and to a particular step in a predetermined method for placing the headgear assembly on the head of the animal.

In accordance with another aspect of the present invention, an instructional system for placing headgear on an animal such as a horse is provided. This system includes a headgear assembly such as a halter or bridle, wherein the headgear assembly further includes multiple interconnected structural components that include a crownpiece, first and second cheekpieces, a noseband, a throatlatch, and a connecting strap disposed between the noseband and the throatlatch; and a plurality of color-coded members releasably mounted on certain of the interconnected components, wherein the color of each of the color-coded member corresponds both to a predetermined location on the head of the animal and to a particular step in a predetermined method for placing the headgear assembly on the head of the animal.

In yet another aspect of this invention, an instructional system for placing headgear on an animal such as a horse or other livestock is provided. This system includes a headgear assembly such as a halter or bridle, wherein the headgear assembly further includes multiple interconnected structural components that include a crownpiece, a browband, a throatlatch, a noseband, a first cheekpiece having a first bit ring attached thereto, a second cheekpiece having a second bit ring attached thereto, a first rein attached to the first bit ring, and a second rein attached to the second bit ring; and a plurality of color-coded members releasably mounted on certain of the interconnected components, wherein the color of each of the color-coded member corresponds both to a predetermined location on the head of the animal and to a particular step in a predetermined method for placing the headgear assembly on the head of the animal.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a side perspective view of a horse halter in accordance with a first exemplary embodiment of the present invention; and

FIG. 2 is a side perspective view of a horse bridle in accordance with a second exemplary embodiment of the present invention.

### DETAILED DESCRIPTION OF THE INVENTION

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

A halter is typically used to lead or tie up livestock and other animals. This device fits behind the animal's ears and around its muzzle. A lead line or leash is typically attached to the halter and is used to lead or tie the animal. The purpose of a halter is to catch, hold, lead and tie an animal; however, a halter is not intended for use in riding an animal such as a horse. The primary difference between a halter and a bridle is that a halter is used by a handler on the ground to lead or tie up an animal, but a bridle is generally used by an individual who is riding an animal. Most if not all halters include a crownpiece; a throatlatch; at least two cheekpieces; a noseband; a tie ring; and various buckles and metal connecting rings that function as articulation points in most versions of the item.

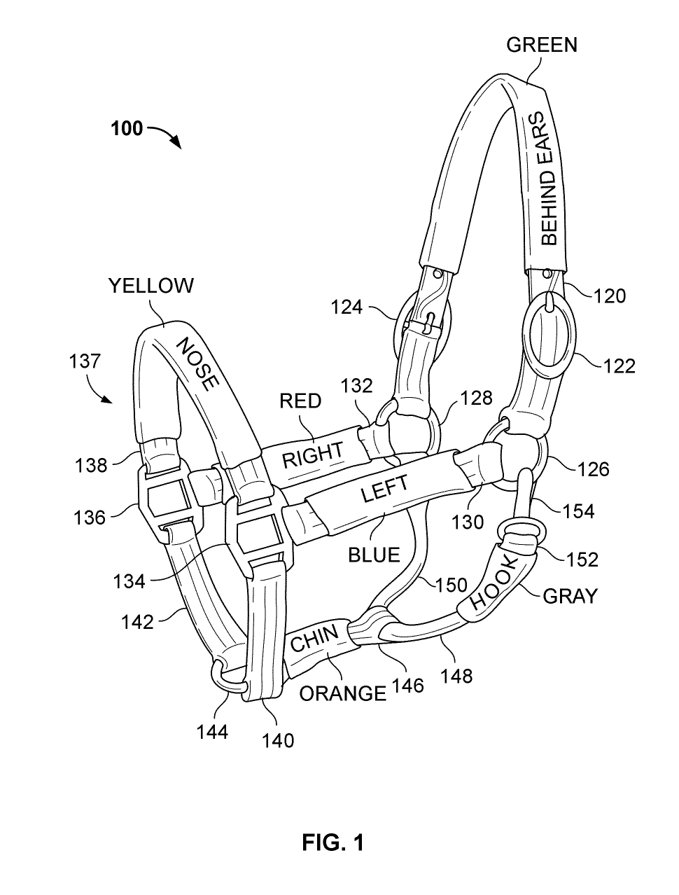

With specific reference to FIG. 1, horse halter 100 includes crownpiece 120 that further includes left and right buckles 122 and 124, respectively. Crownpiece 120 is connected to left cheekpiece 130 by left connecting ring 126 and to right cheekpiece 132 by right connecting ring 128. Left cheekpiece 130 is connected to left connecting ring 134 and right cheekpiece 132 is connected to right connecting ring 136. Noseband 137 includes nosepiece 138 and left and right chinpiece segments 140 and 142 respectively. Left connecting ring 134 also connects nosepiece 138 to left chinpiece segment 140 and right connecting ring 136 also connects the opposite side of nosepiece 138 to right chinpiece segment 142. Tie ring 144 connects the two chinpiece segments to one another. Connecting strap 146 runs between tie ring 144 and left and right throatlatch segments 148 and 150 respectively. Right throatlatch segment 150 connects to right connecting ring 128. Left throatlatch segment 148 broadens into segment 152 which is attached to snap or clasp 154, which in turn attaches to left connecting ring 126. In this exemplary embodiment, a green member or sleeve is mounted on crownpiece 120 (the phrase “behind ears” may be printed on this sleeve); a red sleeve is mounted on right cheekpiece 132 (the word “right” may be printed on this sleeve); a blue sleeve is mounted on left cheekpiece 130 (the word “left” may be printed on this sleeve); a yellow sleeve is mounted on nosepiece 138 (the word “nose” may be printed on this sleeve); an orange sleeve is mounted on connecting strap 146 (the word “chin” may be printed on this sleeve); and a grey sleeve is mounted on throatlatch segment 152 (the word “hook” may be printed on this sleeve). The individual colors of the color-coded sleeves and any instructional text printed thereon may be varied or substituted for one another in any number of combinations in alternate embodiments of this invention.

As previously indicated, the color of each sleeve corresponds both to a predetermined location on the head of the animal and to a particular step in a predetermined method for placing halter 100 on the head of the animal. Using the color-coded scheme described above, an exemplary method for placing halter 100 on the head of the animal includes a trainee executing the steps of: (i) standing on the left side of a horse, pony, or foal, unbuckle halter 100; (ii) placing the green sleeved portion in the right hand; (iii) the animal's mouth and nose go down and through so that the yellow sleeved portion fits over the nose; (iv) at the same time and with the right hand holding the green sleeved portion, sliding up the front of the animal's face, and pulling crownpiece 120 over behind ears; (v) engaging the clasp at the end of the grey sleeved portion; and (vi) attaching a lead rope to tie ring 144, which is located at the forward end of the orange sleeved portion. The red (right) and blue (left) sleeves mounted on the cheekpieces assist with proper orientation of halter 100 relative to the animal's head.

A bridle is used to direct a horse while seated on the animal. While there are a number of different configurations for a bridle, most horse bridles include a crownpiece that is placed over the horse's head just behind the animal's ears for holding the remaining parts of the bridle in place; at least two cheekpieces that attach to either side of the crownpiece and run down the side of the horse's face, along the cheekbone and attach to the bit rings; a throatlatch that runs from the horse's right ear, under the horse's throat, and attaches below the left ear for preventing the bridle from coming off over the horse's head; a browband that runs from just under one ear of the horse, across the forehead, to just under the other ear for preventing the bridle from sliding onto the animal's upper neck; a noseband that encircles the nose of the horse for keeping the animal's mouth closed; reins that attach to the bit, below the attachment for the cheekpieces; and a bit that goes into the horse's mouth, resting on the sensitive interdental space between the horse's teeth.

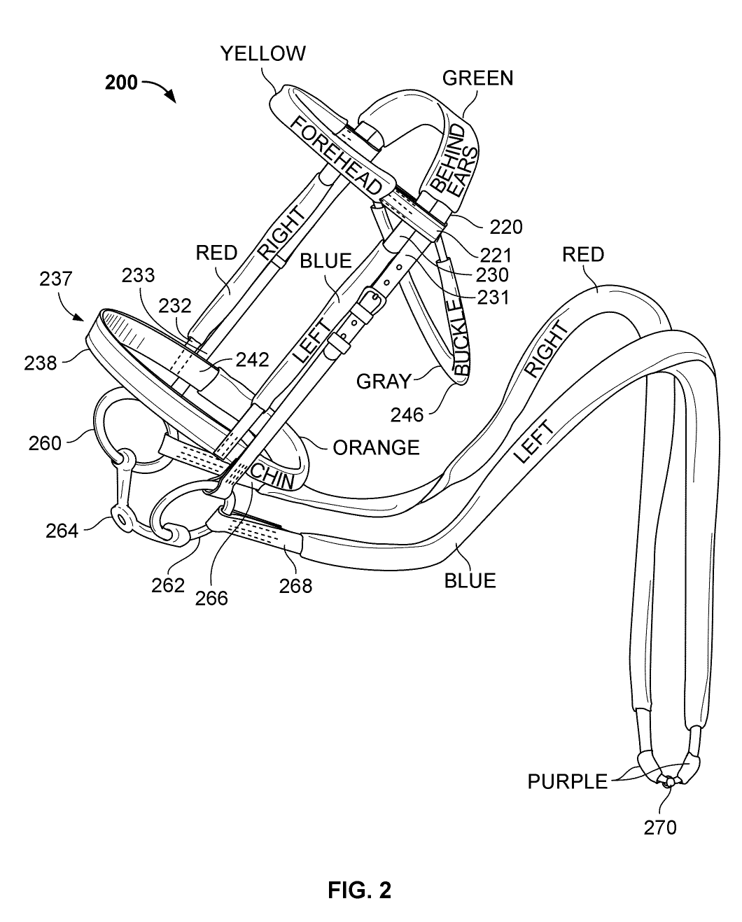

With specific reference to FIG. 2, bridle 200 includes crownpiece 220, to which browband 221 is attached. Attached to browband 221 are left cheekpieces 230 and 231 and right cheekpieces 232 and 233, as well as throatlatch 246. Cheekpieces 230 and 232 are attached to noseband 237, which includes nosepiece 238 and chinpiece 242. Right bit ring 260 is connected to right cheekpiece 233 and left bit ring 262 is connected to left cheekpiece 231. Bit 264 runs between and is connected to bit rings 260 and 262. Right rein 266 is connected to right bit ring 260 and left rein 268 is connected to left bit ring 262. The left and right reins are joined at region 270. In this exemplary embodiment, a green member or sleeve is mounted on crownpiece 220 (the phrase “behind ears” may be printed on this sleeve); a red sleeve is mounted on one of the right cheekpieces 232 or 233 (the word “right” may be printed on this sleeve) and a blue sleeve is mounted on one of the left cheekpieces 230 or 231 (the word “left” may be printed on this sleeve); a yellow sleeve is mounted on browband 221 (the word “forehead” may be printed on this sleeve); an orange sleeve is mounted on a chinpiece 240 (the word “chin” may be printed on this sleeve); a grey sleeve is mounted on throatlatch 246 (the word “buckle” may be printed on this sleeve); a red sleeve is mounted on right rein 266 (the word “right” may be printed on this sleeve); a blue sleeve is mounted on left rein 268 (the word “left” may be printed on this sleeve), and a purple sleeve is mounted on the terminal portion of each rein near region 270. The individual colors of the color-coded sleeves and any instructional text printed thereon may be varied or substituted for one another in any number of combinations in alternate embodiments of this invention.

As previously indicated, the color of each sleeve corresponds both to a predetermined location on the head of the animal and to a particular step in a predetermined method for placing bridle 200 on the head of the animal. Using the color-coded scheme described above, an exemplary method for placing bridle 200 on the head of the animal includes a trainee executing the steps of: (i) standing on the left side of a horse, pony, or foal; (ii) placing the green sleeved portion in the right hand and bringing bridle 200 up in front of horse's head/face; (iii) pulling bridle 200 up to the top of horse's head, placing and resting the right arm and hand between the horse's ears, giving the bridle slack and lowering it down; (iv) holding bit 264 with the left hand and guiding the bit into the horse's mouth; (v) orienting the orange sleeved portion behind the animal's chin and not in its mouth; (vi) while sliding bit 264 in the animal's mouth, at the same time pulling upward with the right hand on the green sleeved portion; (vii) pulling the green sleeved portion over and behind the ears, where it will rest; and (viii) buckling the grey sleeved portion. The red (right) and blue (left) sleeves mounted on the cheekpieces assist with proper orientation of bridle 200 relative to the animal's head.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1) An instructional method for placing headgear on an animal, comprising:
(a) providing an instructional headgear assembly, wherein the headgear assembly is specific to an animal of a predetermined type, wherein the instructional headgear assembly corresponds to headgear used on the animal for a predetermined purpose, and wherein the headgear assembly further includes multiple interconnected structural components; and
(b) providing a plurality of color-coded members releasably mounted on certain of the interconnected structural components, wherein each of the color-coded members is a sleeve, and wherein the color of each of the color-coded sleeves corresponds both to a predetermined location on the head of the animal and to a particular step in a predetermined sequence of steps for properly placing the headgear assembly on the head of the animal, and
(d) using the color-coded members to teach proper placement of the headgear on the animal in accordance with the predetermined sequence of steps.

2) The method of claim 1, wherein the instructional headgear assembly further includes a horse halter; a horse bridle; or a combination thereof.

3) An instructional method for placing headgear on a horse, comprising:
(a) providing an instructional headgear assembly, wherein the headgear assembly is specific to a horse, wherein the instructional headgear assembly corresponds to headgear used on the horse for a predetermined purpose, wherein the headgear assembly further includes multiple interconnected structural components, and wherein the multiple interconnected structural components further include: a crownpiece; a first cheekpiece; a second cheekpiece; a noseband; a throatlatch; and a connecting strap disposed between the noseband and the throatlatch;
(b) providing a plurality of color-coded members releasably mounted on certain of the interconnected structural components, wherein each of the color-coded members is a sleeve, and wherein the color of each of the color-coded sleeves corresponds both to a predetermined location on the head of the horse and to a particular step in a predetermined sequence of steps for properly placing the headgear assembly on the head of the horse, and
(c) using the color-coded members to teach proper placement of the headgear on the horse in accordance with the predetermined sequence of steps.

4) The method of claim 3, further comprising the step of mounting a green color-coded member bearing the phrase “behind head” on the crownpiece.

5) The method of claim 3, further comprising the steps of mounting a red color-coded member bearing the word “right” on the first cheekpiece, and mounting a blue color-coded member bearing the word “left” on the second cheekpiece.

6) The method of claim 3, further comprising the step of mounting a yellow color-coded member bearing the word “nose” on the top portion of the noseband.

7) The method of claim 3, further comprising the step of mounting an orange color-coded member bearing the word “chin” on the connecting strap.

8) The method of claim 3, further comprising the step of mounting a grey color-coded member bearing the word “hook” on a portion of the throatlatch.

9) The method of claim 3, wherein the instructional headgear assembly is a horse halter, a horse bridle, or a combination thereof.

10) The method of claim 3, wherein the instructional headgear assembly is a horse halter and wherein the predetermined sequence of steps further comprises:
(a) providing an animal, wherein the animal is a horse, pony or foal;
(b) standing on the left side of the animal and unbuckling the halter;
(c) placing the crownpiece in a trainee's right hand;
(d) lowering the animal's mouth and nose down and through the halter so that the browband fits over the animal's nose;
(e) at the same time and with the right hand holding the crownpiece, sliding the right hand up the front of the animal's face, and pulling the crownpiece over and behind the animal's ears;
(f) engaging the clasp at the end of the throatlatch; and
(g) attaching a lead rope to a tie ring located at a forward end of the noseband.

11) The method of claim 3, wherein the instructional headgear assembly is a horse bridle and wherein the predetermined sequence of steps further comprises:
(a) providing an animal, wherein the animal is a horse, pony or foal;
(b) standing on the left side of the animal;
(c) placing the crownpiece in a trainee's right hand and bringing the bridle up in front of the animal's head or face;
(d) pulling the bridle up to the top of the animal's head, placing and resting a trainee's right arm and right hand between the animal's ears, giving the bridle slack and lowering the bridle down;
(e) holding the bit with a trainee's left hand and guiding the bit into the animal's mouth;
(f) orienting the noseband behind animal's chin;
(g) while sliding the bit in the animal's mouth, at the same time pulling upward with the trainee's right hand on the crownpiece;
(h) pulling the crownpiece over and behind the ears where the crownpiece will rest; and
(i) buckling the throatlatch.

12) An instructional method for placing headgear on a horse, comprising:
(a) providing an instructional headgear assembly, wherein the headgear assembly is specific a horse, wherein the instructional headgear assembly corresponds to headgear used on the horse for a predetermined purpose, wherein the headgear assembly further includes multiple interconnected structural components, and wherein the multiple interconnected structural components further include: a crownpiece; a browband; a throatlatch; a noseband; a first cheekpiece having a first bit ring attached thereto; a second cheekpiece having a second bit ring attached thereto; a first rein attached to the first bit ring; and a second rein attached to the second bit ring;
(b) providing a plurality of color-coded members releasably mounted on certain of the interconnected structural components, wherein each of the color-coded members is a sleeve, and wherein the color of each of the color-coded sleeves corresponds both to a predetermined location on the head of the horse and to a particular step in a predetermined sequence of steps for properly placing the headgear assembly on the head of the horse; and
(c) using the color-coded members to teach proper placement of the headgear on the horse in accordance with the predetermined sequence of steps.

13) The method of claim 12, further comprising the step of mounting a green color-coded member bearing the phrase “behind head” on the crownpiece.

14) The method of claim 12, further comprising the steps of mounting a red color-coded member bearing the word “right” on the first cheekpiece, and mounting a blue color-coded member bearing the word “left” on the second cheekpiece.

15) The method of claim 12, further comprising the step of mounting a yellow color-coded member bearing the word “forehead” on the browband.

16) The method of claim 12, further comprising the step of mounting an orange color-coded member bearing the word “chin” on a portion of the noseband.

17) The method of claim 12, further comprising the step of mounting a grey color-coded member bearing the word “buckle” on the throatlatch.

18) The method of claim 12, further comprising the steps of mounting a red color-coded member bearing the word “right” on the first rein, mounting a blue color-coded member bearing the word “left” on the second rein, and further mounting a purple color-coded member on the terminal portion of each rein.

19) The method of claim 12, wherein the instructional headgear assembly is a horse halter and wherein the predetermined sequence of steps further comprises:
(a) providing an animal, wherein the animal is a horse, pony or foal;
(b) standing on the left side of the animal and unbuckling the halter;
(c) placing the crownpiece in a trainee's right hand;
(d) lowering the animal's mouth and nose down and through the halter so that the browband fits over the animal's nose;
(e) at the same time and with the right hand holding the crownpiece, sliding the right hand up the front of the animal's face, and pulling the crownpiece over and behind the animal's ears;
(f) engaging the clasp at the end of the throatlatch; and
(g) attaching a lead rope to a tie ring located at a forward end of the noseband.

20) The method of claim 12, wherein the instructional headgear assembly is a horse bridle and wherein the predetermined sequence of steps further comprises:
(a) providing an animal, wherein the animal is a horse, pony or foal;
(b) standing on the left side of the animal;
(c) placing the crownpiece in a trainee's right hand and bringing the bridle up in front of the animal's head or face;
(d) pulling the bridle up to the top of the animal's head, placing and resting a trainee's right arm and right hand between the animal's ears, giving the bridle slack and lowering the bridle down;
(e) holding the bit with a trainee's left hand and guiding the bit into the animal's mouth;
(f) orienting the noseband behind animal's chin;
(g) while sliding the bit in the animal's mouth, at the same time pulling upward with the trainee's right hand on the crownpiece;
(h) pulling the crownpiece over and behind the ears where the crownpiece will rest; and
(i) buckling the throatlatch.
